(19) United States
(12) Patent Application Publication
(10) Pub. No.: US 2007/0234635 A1
(43) Pub. Date: Oct. 11, 2007

(54) Method and apparatus for integrated weighted nymph form and fishing hooks

(76) Inventor: Theodore Carroll Lewis, Nahant, MA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/399,943

(22) Filed: Apr. 6, 2006

(51) Int. Cl. A01K 83/00; A01K 85/08

(52) U.S. Cl. 43/44.81; 43/42.25

(57) ABSTRACT

An integrated hook and a nymph form shaped weight. The nymph form shaped weight is formed on the hook. The weight of the nymph form shaped weight is proportioned to a size of the hook. A method includes providing a fishing hook and forming a nymph form shaped weight directly on the hook. The nymph form shaped weight is sized proportionally to a size of the hook.

### BACKGROUND

1. Field

The embodiments relate to fly fishing flies, and more particularly to fly fishing flies having an integrated nymph shaped weight and fishing hook.

2. Description of the Related Art

Fly fishing is an ancient and distinct angling method, developed primarily for salmonids (trout and salmon, mostly) and now extended to other species such as pike, bass, and carp, as well as a wide range of marine species. Artificial flies are constructed, that is “tied,” onto a hook with thread, fur, feathers and other materials in sizes and colors to match naturally occurring food (i.e., nymphs, insects, etc.) or simply to excite a fish. The fly itself can weigh very little and is normally attached to the line by a leader, which may taper to a very fine line at the tip end, also called the tippet.

There are two basic forms of fly fishing, dry or wet. Dry flies are coated with a floatant and sit on the surface of the water. They are mostly cast upstream in moving water when fishing for trout. Wet flies are divided into other types such as nymphs, streamers and true wet flies and they are all fished beneath the surface of the water. In order to get the wet fly beneath the surface of the water, weights are added to the fly. FIGS. 1A-B illustrates a tying method of adding a weight to a fly. As illustrated in FIG. 1A, the line is placed through a through hole in the weight. As illustrated in FIG. 1B, the weight is then tied to the fly. FIG. 2A illustrates another method of adding weight to a fly. As illustrated, lead wire is wrapped around a hook. In this method, sometimes fast drying glue is first placed on the hook and the wire is then wrapped around the portion of the hook where the glue was placed.

The problem with the methods illustrated in FIGS. 1A-B and FIG. 2 is that adding weight to a fly can be very time consuming, especially when having to tie many flies. Also, the shape of the fly is not accurate to an actual nymph/insect.

### SUMMARY

One embodiment includes a weighted nymph formed on a hook. The life sized shaped weight is accurately sized to an actual nymph and proportioned to the size hook needed.

Another embodiment includes an integrated hook and a life form shaped weight. The life form shaped weight being formed on the hook. The weight of the life form shaped weight is proportioned to the size of the hook.

Yet another embodiment is a method including providing a fishing hook and a nymph shaped weight directly on the fishing hook. The nymph shaped weight is sized proportionally to the size of a nymph/insect.

### BRIEF DESCRIPTION OF THE DRAWINGS

The embodiments are illustrated by way of example, and not by way of limitation, in the figures of the accompanying drawings and in which like reference numerals refer to similar elements and in which:

FIG. 1A-B illustrate a prior art technique of tying a weight to a fishing hook;

FIG. 2 illustrates a prior art of adding weight to a fishing hook by wrapping lead wire around the hook;

FIG. 3A illustrates a side view of an embodiment having an actual mayfly shaped integrated weight and fishing hook;

FIG. 3B illustrates a front view of an embodiment having an actual mayfly shaped integrated weight and fishing hook;

FIG. 3C illustrates a rear view of an embodiment having an actual mayfly shaped integrated weight and fishing hook;

FIG. 4A illustrates a side view of an embodiment having an actual scud and pupa shaped integrated weight and fishing hook;

FIG. 4B illustrates a front view of an embodiment having an actual scud and pupa shaped integrated weight and fishing hook;

FIG. 4C illustrates a rear view of an embodiment having an actual scud and pupa shaped integrated weight and fishing hook;

FIG. 5A illustrates a side view of an embodiment having an actual stonefly nymph shaped integrated weight and fishing hook;

FIG. 5B illustrates a front view of an embodiment having an actual stonefly nymph shaped integrated weight and fishing hook;

FIG. 5C illustrates a rear view of an embodiment having an actual stonefly nymph shaped integrated weight and fishing hook;

FIG. 6A illustrates a side view of an embodiment having an actual caddis nymph shaped integrated weight and fishing hook;

FIG. 6B illustrates a front view of an embodiment having an actual caddis nymph shaped integrated weight and fishing hook;

FIG. 6C illustrates a rear view of an embodiment having an actual caddis nymph shaped integrated weight and fishing hook;

FIG. 7A illustrates a side view of an embodiment having an actual medium sized stonefly nymph shaped integrated weight and fishing hook;

FIG. 7B illustrates a front view of an embodiment having an actual medium sized stonefly nymph shaped integrated weight and fishing hook;

FIG. 7C illustrates a rear view of an embodiment having an actual medium sized stonefly nymph shaped integrated weight and fishing hook;

FIG. 8A illustrates a side view of an embodiment having an actual caddis nymph shaped integrated weight and fishing hook;

FIG. 8B illustrates a rear view of an embodiment having an actual caddis nymph shaped integrated weight and fishing hook;

FIG. 8C illustrates a front view of an embodiment having an actual caddis nymph shaped integrated weight and fishing hook;

FIG. 9A illustrates a side view of an embodiment having an actual hellgrammite shaped integrated weight and fishing hook;

FIG. 9B illustrates a front view of an embodiment having an actual hellgrammite shaped integrated weight and fishing hook;

FIG. 9C illustrates a rear view of an embodiment having an actual hellgrammite shaped integrated weight and fishing hook;

FIG. 10A illustrates a side view of an embodiment having an actual longer hellgrammite shaped integrated weight and fishing hook than the embodiment illustrated in FIG. 9A-C;

FIG. 10B illustrates a front view of an embodiment having an actual longer hellgrammite shaped integrated weight and fishing hook than the embodiment illustrated in FIG. 9A-C;

FIG. 10C illustrates a rear view of an embodiment having an actual longer hellgrammite shaped integrated weight and fishing hook than the embodiment illustrated in FIG. 9A-C;

FIG. 11 illustrates a block diagram of a process of forming an integrated fishing hook and nymph/insect weight; and

FIG. 12 illustrates a block diagram including details for block 1120 illustrated in FIG. 11.

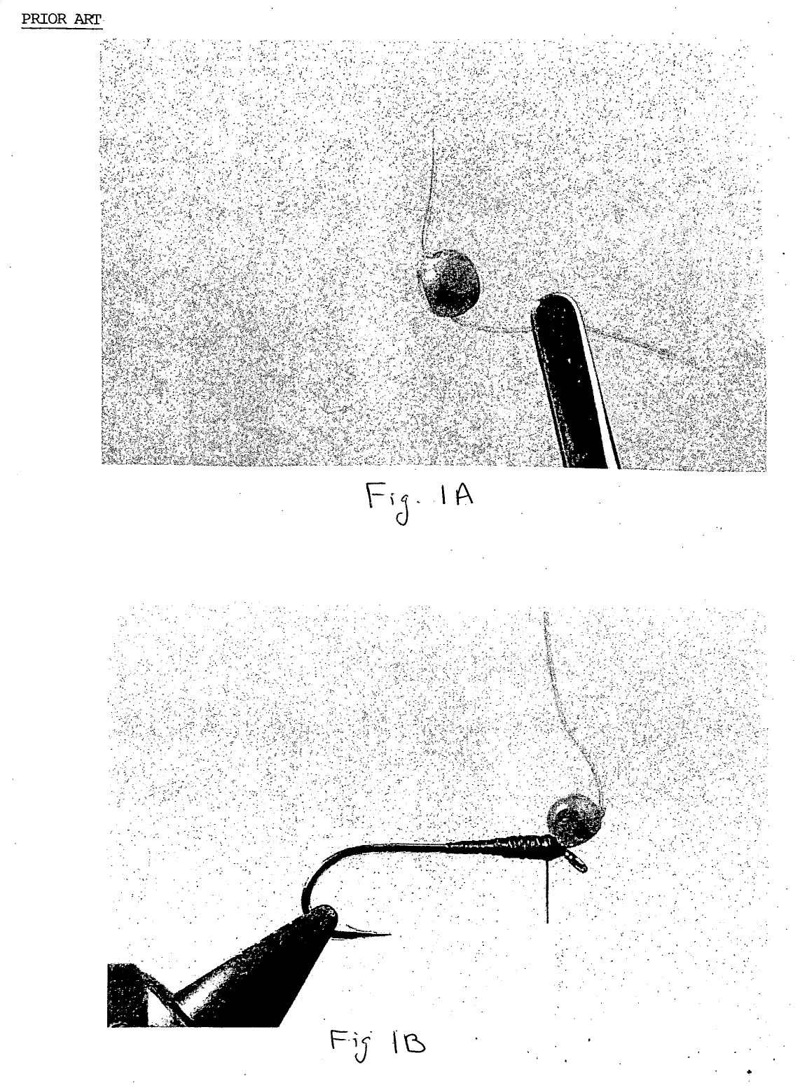

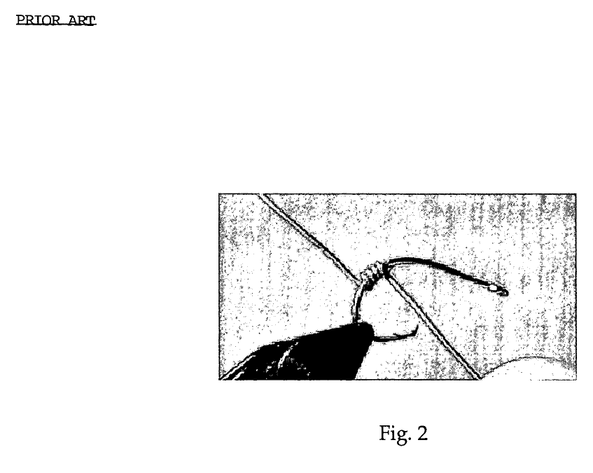

### DETAILED DESCRIPTION OF THE INVENTION

The invention generally relates to fly fishing flies having an integrated weighted nymph form and fishing hook. Referring to the figures, exemplary embodiments of the invention will now be described. The exemplary embodiments are provided to illustrate the invention and should not be construed as limiting the scope of the invention.

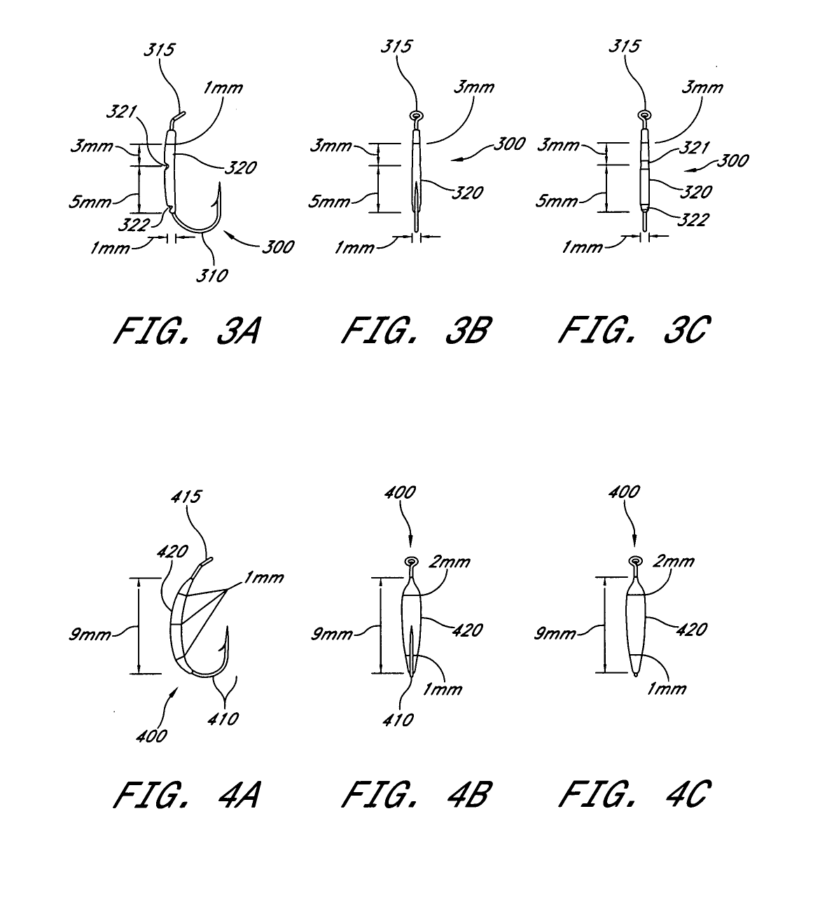

FIG. 3A illustrates a side view of an embodiment of a life form shaped weight material molded and integrated with a fishing hook (fly 300). In one embodiment the life form is an insect or nymph. FIG. 3B illustrates a front view of fly 300. FIG. 3C illustrates a rear view of fly 300. In this embodiment, the shaped weight is shaped and sized as a mayfly and proportioned for either a #14 wet fly or nymph hook. In one embodiment, fly 300 includes integrated fishing hook 310, line attachment 315 (having a through hole), and weighted material 320. The nymph shaped weight 320 is formed on fishing hook 310. Nymph shaped weight 320 is accurately sized to an actual mayfly nymph and proportioned to the size of fishing hook 310. That is, fishing hook 310 is the correct hook size for a mayfly nymph.

In one embodiment nymph shaped weight 320 is made of either lead, tungsten, tin, bismuth, steel or a tungsten-nickel alloy. In another embodiment nymph shaped weight 320 is made of ceramic material, solid rubber or plastic.

In one embodiment nymph shaped weight 320 is molded directly on fishing hook 310. In this embodiment the weight of nymph shaped weight 320 is proportional to the size of fishing hook 310.

In one embodiment nymph shaped weight 320 has a head portion located near or at line attachment 315 and a tail portion located toward the barbed hooked portion of fishing hook 310. In one embodiment fishing hook 310 is centered within nymph shaped weight 320.

In one embodiment, nymph shaped weight 320 includes grooves 321 and 322. In this embodiment, groove 321 is located toward the bend of fishing hook 310 and groove 322 is located toward the middle of nymph shaped weight 320. Groove 321 is a starting point at the tail end of nymph shaped weight 320 and prevents thread from sliding off the nymph shaped weight 320 when a tier is tying other parts of the fly onto the nymph shaped weight 320. Groove 322 is placed at the proper distance from the tail so that the wing case is correct every time a fly is tied. In this embodiment, because the nymph shaped weight 320 has actual correct size and proportions, with the correct placement of grooves 321 and 322 a tied fly will look correct every time.

In the above embodiment, because nymph shaped weight 320 is formed or molded onto fishing hook 310, a fly tier does not have to spend time finding a fishing hook sized for a mayfly or select and tie a weight onto fishing hook 310. Since nymph shaped weight 320 is accurately proportioned to an actual mayfly and correctly weighted for the type of fly fishing, fly tiers have the convenience of having the weight and shape already set up for them. This also provides the correct sized hook for the type of nymph selected.

FIG. 4A illustrates a side view of an embodiment of a nymph form shaped weight material molded and integrated with a fishing hook (fly 400). In one embodiment the life form is an insect or nymph. FIG. 4B illustrates a front view of fly 400. FIG. 4C illustrates a rear view of fly 400. In this embodiment, the shaped weight is shaped and sized as a scud or pupa and proportioned for a #12 fishing hook. In one embodiment, fly 400 includes integrated fishing hook 410, line attachment 415 (having a through hole), and weighted material 420. The nymph shaped weight 420 is formed on fishing hook 410. Nymph shaped weight 420 is accurately sized to an actual scud or pupa and proportioned to the size of fishing hook 410. That is, fishing hook 410 is the correct fishing hook size for a scud or pupa.

In one embodiment nymph shaped weight 420 is made of either lead, tungsten, tin, bismuth, steel or a tungsten-nickel alloy. In another embodiment nymph shaped weight 420 is made of ceramic material, solid rubber or plastic.

In one embodiment nymph shaped weight 420 is molded directly on fishing hook 410. In this embodiment the weight of nymph shaped weight 420 is proportional to the size of fishing hook 410.

In one embodiment nymph shaped weight 420 has a head portion located near or at line attachment 415 and a tail portion located toward the barbed hooked portion of fishing hook 410. In one embodiment fishing hook 410 is centered within nymph shaped weight 420.

In the above embodiment, because nymph shaped weight 420 is formed or molded onto fishing hook 410, a fly tier does not have to spend time finding a fishing hook sized for a scud or pupa, or select and tie a weight onto fishing hook 410. Since nymph shaped weight 420 is accurately proportioned to an actual scud and pupa and correctly weighted for the type of fly fishing, fly tiers can have the convenience of having the weight and shape already set up for them. This also provides the correct sized hook for the type of nymph selected.

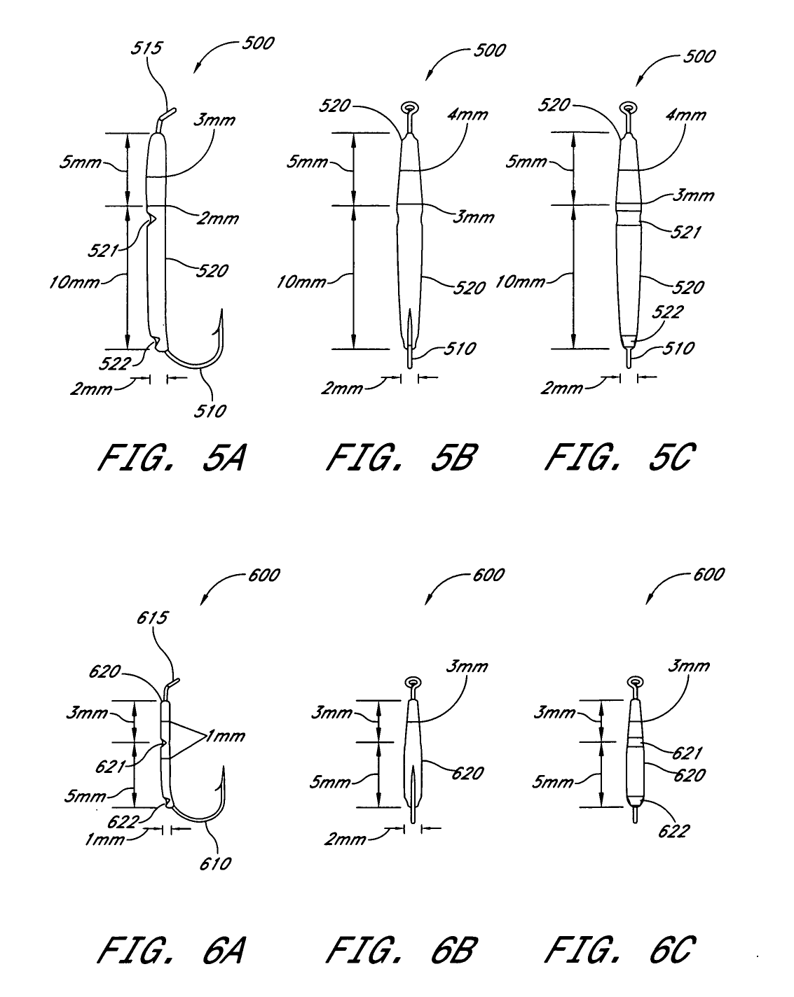

FIG. 5A illustrates a side view of an embodiment of a life form shaped weight material molded and integrated with a fishing hook (fly 500). In one embodiment the life form is an insect or nymph. FIG. 5B illustrates a front view of fly 500. FIG. 5C illustrates a rear view of fly 500. In this embodiment, the shaped weight is shaped and sized as a nymph proportioned to a #6, #8 or #10 nymph fishing hook. In one embodiment, fly 500 includes integrated fishing hook 510, line attachment 515 (having a through hole), and weighted material 520. The nymph shaped weight 520 is formed on fishing hook 510. Nymph shaped weight 520 is accurately sized to an actual nymph and proportioned to the size of fishing hook 510. That is, fishing hook 510 is the correct fishing hook size for that nymph.

In one embodiment nymph shaped weight 520 is made of either lead, tungsten, tin, bismuth, steel or a tungsten-nickel alloy. In another embodiment nymph shaped weight 520 is made of ceramic material, solid rubber or plastic.

In one embodiment nymph shaped weight 520 is molded directly on fishing hook 510. In this embodiment the weight of nymph shaped weight 520 is proportional to the size of fishing hook 510.

In one embodiment nymph shaped weight 520 has a head portion located near or at line attachment 515 and a tail portion located toward the barbed hooked portion of fishing hook 510. In one embodiment fishing hook 510 is centered within nymph shaped weight 520.

In the above embodiment, because nymph shaped weight 520 is formed or molded onto fishing hook 510, a fly tier does not have to spend time finding a fishing hook sized for a nymph or select and tie a weight onto fishing hook 510. Since nymph shaped weight 520 is accurately proportioned to an actual nymph and correctly weighted for the type of fly fishing, fly tiers can have the convenience of having the weight and shape already set up for them. This also provides the correct sized hook for the type of nymph selected.

In one embodiment, nymph shaped weight 520 includes grooves 521 and 522. In this embodiment, groove 521 is located toward the fishing hook 510 and groove 522 is located toward the middle of nymph shaped weight 520. Groove 521 is a starting point at the tail end of nymph shaped weight 520 and prevents thread from sliding off the nymph shaped weight 520 when a tier is tying other parts of the fly onto the nymph shaped weight 520. Groove 522 is placed at the proper distance from the tail so that the wing case is correct every time a fly is tied. In this embodiment, because the nymph shaped weight 520 has actual correct size and proportions, with the correct placement of grooves 521 and 522 a tied fly will look correct every time.

FIG. 6A illustrates a side view of an embodiment of a life form shaped weight material molded and integrated with a fishing hook (fly 600). In one embodiment the life form is an insect or nymph. FIG. 6B illustrates a front view of fly 600. FIG. 6C illustrates a rear view of fly 600. In this embodiment, the shaped weight is shaped and sized as a caddis nymph proportioned to a #10 or #12 wet fly fishing hook. In one embodiment, fly 600 includes integrated fishing hook 610, line attachment 615 (having a through hole), and weighted material 620. The nymph shaped weight 620 is formed on fishing hook 610. Nymph shaped weight 620 is accurately sized to an actual nymph and proportioned to the size of fishing hook 610. That is, fishing hook 610 is the correct fishing hook size for a caddis nymph.

In one embodiment nymph shaped weight 620 is made of either lead, tungsten, tin, bismuth, steel or a tungsten-nickel alloy. In another embodiment nymph shaped weight 620 is made of ceramic material, solid rubber or plastic.

In one embodiment nymph shaped weight 620 is molded directly on fishing hook 610. In this embodiment the weight of nymph shaped weight 620 is proportional to the size of fishing hook 610.

In one embodiment nymph shaped weight 620 has a head portion located near or at line attachment 615 and a tail portion located toward the barbed hooked portion of fishing hook 610. In one embodiment fishing hook 610 is centered within nymph shaped weight 620.

In the above embodiment, because nymph shaped weight 620 is formed or molded onto fishing hook 610, a fly tier does not have to spend time finding a fishing hook sized for a nymph or select and tie a weight onto fishing hook 610. Since nymph shaped weight 620 is accurately proportioned to an actual caddis nymph and correctly weighted for the type of fly fishing, fly tiers can have the convenience of having the weight and shape already set up for them. This also provides the correct sized hook for the type of nymph selected.

In one embodiment, nymph shaped weight 620 includes grooves 621 and 622. In this embodiment, groove 621 is located toward the fishing hook 610 and groove 622 is located toward the middle of nymph shaped weight 620. Groove 621 is a starting point at the tail end of nymph shaped weight 620 and prevents thread from sliding off the nymph shaped weight 620 when a tier is tying other parts of the fly onto the nymph shaped weight 620. Groove 622 is placed at the proper distance from the tail so that the wing case is correct every time a fly is tied. In this embodiment, because the nymph shaped weight 620 has actual correct size and proportions, with the correct placement of grooves 621 and 622 a tied fly will look correct every time.

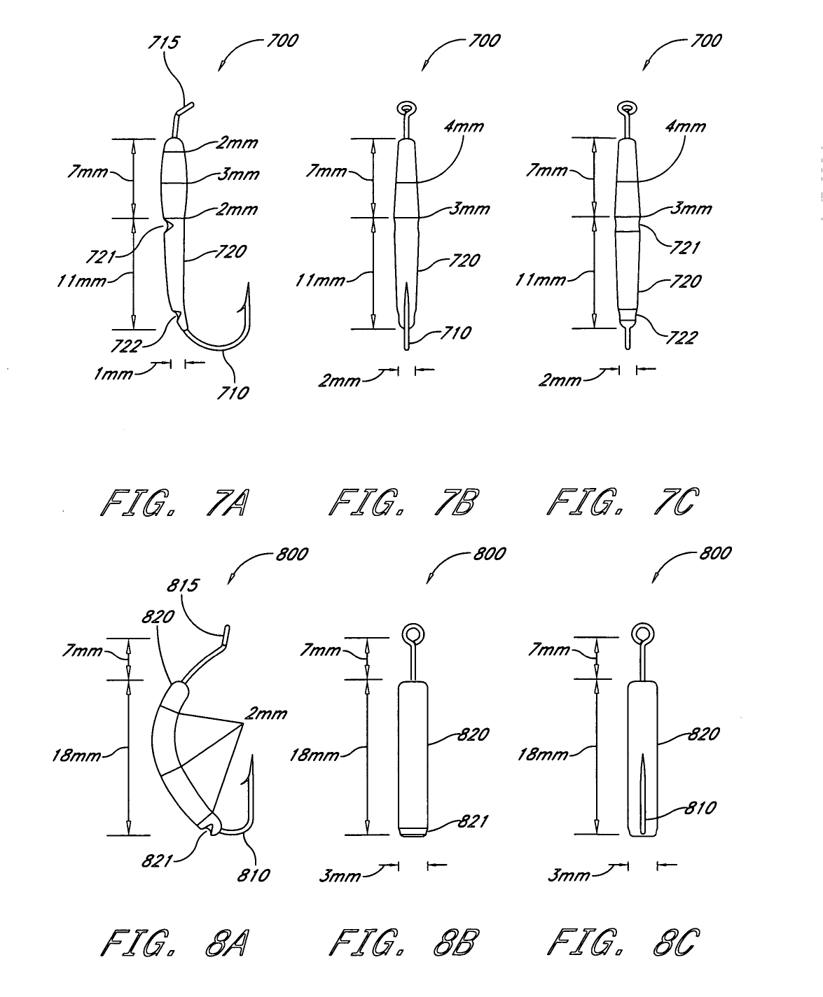

FIG. 7A illustrates a side view of an embodiment of a life form shaped weight material molded and integrated with a fishing hook (fly 700). In one embodiment the life form is an insect or nymph. FIG. 7B illustrates a front view of fly 700. FIG. 7C illustrates a rear view of fly 700. In this embodiment, the shaped weight is shaped and sized as a nymph proportioned to a #6 nymph fishing hook. In one embodiment, fly 700 includes integrated fishing hook 710, line attachment 715 (having a through hole), and weighted material 720. The nymph shaped weight 720 is formed on fishing hook 710. Nymph shaped weight 720 is accurately sized to an actual nymph and proportioned to the size of fishing hook 710. That is, fishing hook 710 is the correct fishing hook size for a large sized nymph.

In one embodiment nymph shaped weight 720 is made of either lead, tungsten, tin, bismuth, steel or a tungsten-nickel alloy. In another embodiment nymph shaped weight 720 is made of ceramic material, solid rubber or plastic.

In one embodiment nymph shaped weight 720 is molded directly on fishing hook 710. In this embodiment the weight of nymph shaped weight 720 is proportional to the size of fishing hook 710.

In one embodiment nymph shaped weight 720 has a head portion located near or at line attachment 715 and a tail portion located toward the barbed hooked portion of fishing hook 710. In one embodiment fishing hook 710 is centered within nymph shaped weight 720.

In the above embodiment, because nymph shaped weight 720 is formed or molded onto fishing hook 710, a fly tier does not have to spend time finding a fishing hook sized for a nymph or select and tie a weight onto fishing hook 710. Since nymph shaped weight 720 is accurately proportioned to an actual medium sized nymph and correctly weighted for the type of fly fishing, fly tiers can have the convenience of having the weight and shape already set up for them. This also provides the correct sized hook for the type of nymph selected.

In one embodiment, nymph shaped weight 720 includes grooves 721 and 722. In this embodiment, groove 721 is located toward the fishing hook 710 and groove 722 is located toward the middle of nymph shaped weight 720. Groove 721 is a starting point at the tail end of nymph shaped weight 720 and prevents thread from sliding off the nymph shaped weight 720 when a tier is tying other parts of the fly onto the nymph shaped weight 720. Groove 722 is placed at the proper distance from the tail so that the wing case is correct every time a fly is tied. In this embodiment, because the nymph shaped weight 720 has actual correct size and proportions, with the correct placement of grooves 721 and 722 a tied fly will look correct every time.

FIG. 8A illustrates a side view of an embodiment of a life form shaped weight material molded and integrated with a fishing hook (fly 800). In one embodiment the life form is an insect or nymph. FIG. 8B illustrates a rear view of fly 800. FIG. 8C illustrates a front view of fly 800. In this embodiment, the shaped weight is shaped and sized for a hellgrammite and proportioned for a curved #10 fishing hook. In one embodiment, fly 800 includes integrated fishing hook 810, line attachment 815 (having a through hole), and weighted material 820. The nymph shaped weight 820 is formed on fishing hook 810. Nymph shaped weight 820 is accurately sized to an actual nymph and proportioned to the size of fishing hook 810. That is, fishing hook 810 is the correct fishing hook size for a hellgrammite.

In one embodiment nymph shaped weight 820 is made of either lead, tungsten, tin, bismuth, steel or a tungsten-nickel alloy. In another embodiment nymph shaped weight 820 is made of ceramic material, solid rubber or plastic.

In one embodiment nymph shaped weight 820 is molded directly on fishing hook 810. In this embodiment the weight of nymph shaped weight 820 is proportional to the size of fishing hook 810.

In one embodiment nymph shaped weight 820 has a head portion located near or at line attachment 815 and a tail portion located toward the barbed hooked portion of fishing hook 810. In one embodiment fishing hook 810 is centered within nymph shaped weight 820.

In the above embodiment, because nymph shaped weight 820 is formed or molded onto fishing hook 810, a fly tier does not have to spend time finding a fishing hook sized for a nymph or select and tie a weight onto fishing hook 810. Since nymph shaped weight 820 is accurately proportioned to an actual hellgrammite and correctly weighted for the type of fly fishing, fly tiers can have the convenience of having the weight and shape already set up for them. This also provides the correct sized hook for the type of nymph selected.

In one embodiment, nymph shaped weight 820 includes a groove 821. In this embodiment, groove 821 is located toward the fishing hook 810. Groove 821 is a starting point at the tail end of nymph shaped weight 820 and prevents thread from sliding off the nymph shaped weight 820 when a tier is tying other parts of the fly onto the nymph shaped weight 820. In this embodiment, because the nymph shaped weight 820 has actual correct size and proportions, with the correct placement of groove 821 a tied fly will look correct every time.

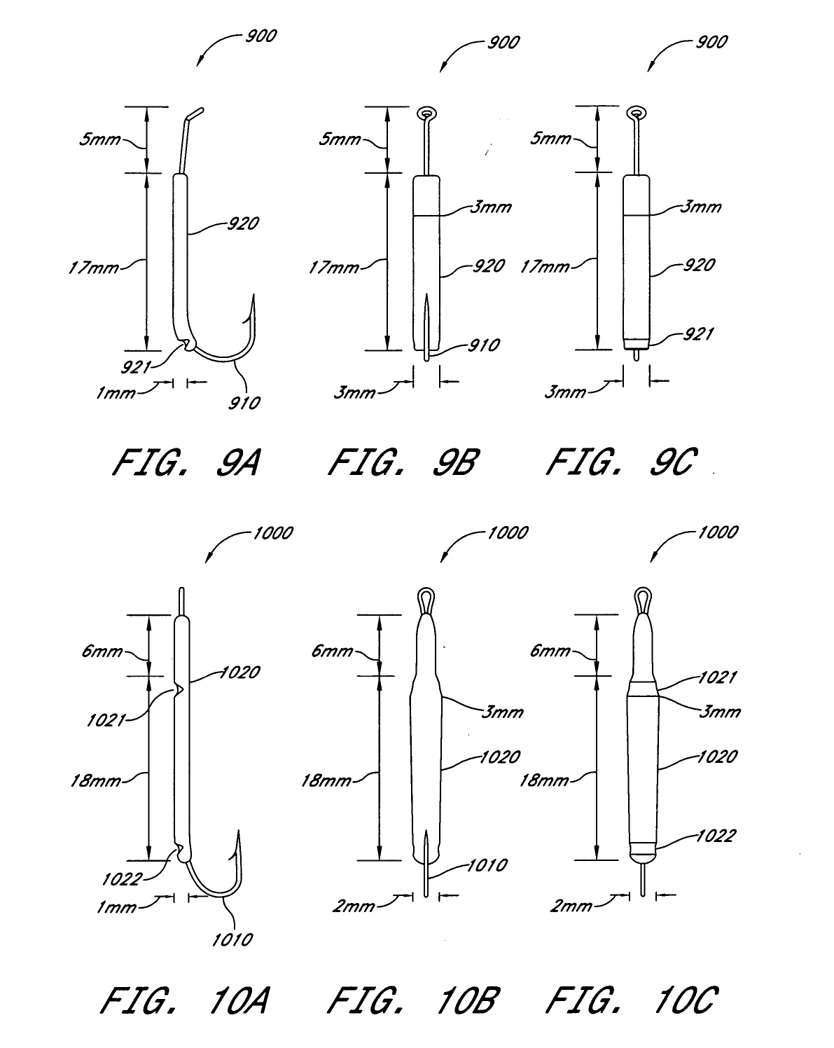

FIG. 9A illustrates a side view of an embodiment of a life form shaped weight material molded and integrated with a fishing hook (fly 900). In one embodiment the life form is an insect or nymph. FIG. 9B illustrates a front view of fly 900. FIG. 9C illustrates a rear view of fly 900. In this embodiment, the shaped weight is shaped and sized as a hellgrammite and proportioned for a #6 fishing hook. In one embodiment, fly 900 includes integrated fishing hook 910, line attachment 915 (having a through hole), and weighted material 920. The nymph shaped weight 920 is formed on fishing hook 910. Nymph shaped weight 920 is accurately sized to an actual nymph and proportioned to the size of fishing hook 910. That is, fishing hook 910 is the correct fishing hook size for a hellgrammite.

In one embodiment nymph shaped weight 920 is made of either lead, tungsten, tin, bismuth, steel or a tungsten-nickel alloy. In another embodiment nymph shaped weight 920 is made of ceramic material, solid rubber or plastic.

In one embodiment nymph shaped weight 920 is molded directly on fishing hook 910. In this embodiment the weight of nymph shaped weight 920 is proportional to the size of fishing hook 910.

In one embodiment nymph shaped weight 920 has a head portion located near or at line attachment 915 and a tail portion located toward the barbed hooked portion of fishing hook 910. In one embodiment fishing hook 910 is centered within nymph shaped weight 920.

In the above embodiment, because nymph shaped weight 920 is formed or molded onto fishing hook 910, a fly tier does not have to spend time finding a fishing hook sized for a nymph or select and tie a weight onto fishing hook 910. Since nymph shaped weight 920 is accurately proportioned to an actual hellgrammite and correctly weighted for the type of fly fishing, fly tiers can have the convenience of having the weight and shape already set up for them. This also provides the correct sized hook for the type of nymph selected.

In one embodiment, nymph shaped weight 920 includes a groove 921. In this embodiment, groove 921 is located toward the fishing hook 910. Groove 921 is a starting point at the tail end of nymph shaped weight 920 and prevents thread from sliding off the nymph shaped weight 920 when a tier is tying other parts of the fly onto the nymph shaped weight 920. In this embodiment, because the nymph shaped weight 920 has actual correct size and proportions, with the correct placement of groove 921 a tied fly will look correct every time.

FIG. 10A illustrates a side view of an embodiment of a life form shaped weight material molded and integrated with a fishing hook (fly 1000). In one embodiment the life form is an insect or nymph. FIG. 10B illustrates a front view of fly 1000. FIG. 10C illustrates a rear view of fly 1000. In this embodiment, the shaped weight is shaped and sized as a hellgrammite and proportioned for a #10 fishing hook. In one embodiment, fly 1000 includes integrated fishing hook 1010, line attachment 1015 (having a through hole), and weighted material 1020. The nymph shaped weight 1020 is formed on fishing hook 1010. Nymph shaped weight 1020 is accurately sized to an actual nymph and proportioned to the size of fishing hook 1010. That is, fishing hook 1010 is the correct fishing hook size for a hellgrammite.

In one embodiment nymph shaped weight 1020 is made of either lead, tungsten, tin, bismuth, steel or a tungsten-nickel alloy. In another embodiment nymph shaped weight 1020 is made of ceramic material, solid rubber or plastic.

In one embodiment nymph shaped weight 1020 is molded directly on fishing hook 1010. In this embodiment the weight of nymph shaped weight 1020 is proportional to the size of fishing hook 1010.

In one embodiment nymph shaped weight 1020 has a head portion located near or at line attachment 1015 and a tail portion located toward the barbed hooked portion of fishing hook 1010. In one embodiment fishing hook 1010 is centered within nymph shaped weight 1020.

In the above embodiment, because nymph shaped weight 1020 is formed or molded onto fishing hook 1010, a fly tier does not have to spend time finding a fishing hook sized for a nymph or select and tie a weight onto fishing hook 1010. Since nymph shaped weight 1020 is accurately proportioned to an actual hellgrammite and correctly weighted for the type of fly fishing, fly tiers can have the convenience of having the weight and shape already set up for them. This also provides the correct sized hook for the type of nymph selected.

In one embodiment, nymph shaped weight 1020 includes grooves 1021 and 1022. In this embodiment, groove 1021 is located toward the fishing hook 1010 and groove 1022 is located toward the middle of nymph shaped weight 1020. Groove 1021 is a starting point at the tail end of nymph shaped weight 1020 and prevents thread from sliding off the nymph shaped weight 1020 when a tier is tying other parts of the fly onto the nymph shaped weight 1020. Groove 1022 is placed at the proper distance from the tail so that the wing case is correct every time a fly is tied. In this embodiment, because the nymph shaped weight 1020 has actual correct size and proportions, with the correct placement of grooves 1021 and 1022 a tied fly will look correct every time.

FIG. 11 illustrates a block diagram of process 1100 for forming a life form shaped weight directly on a fishing hook. In one embodiment the life form is an insect or nymph. Process 1100 begins with block 1110 where a fishing hook is provided. In block 1120 a life form shaped weight is formed directly on the fishing hook. In this embodiment, the life form shaped weight is sized proportionally to the size of the fishing hook.

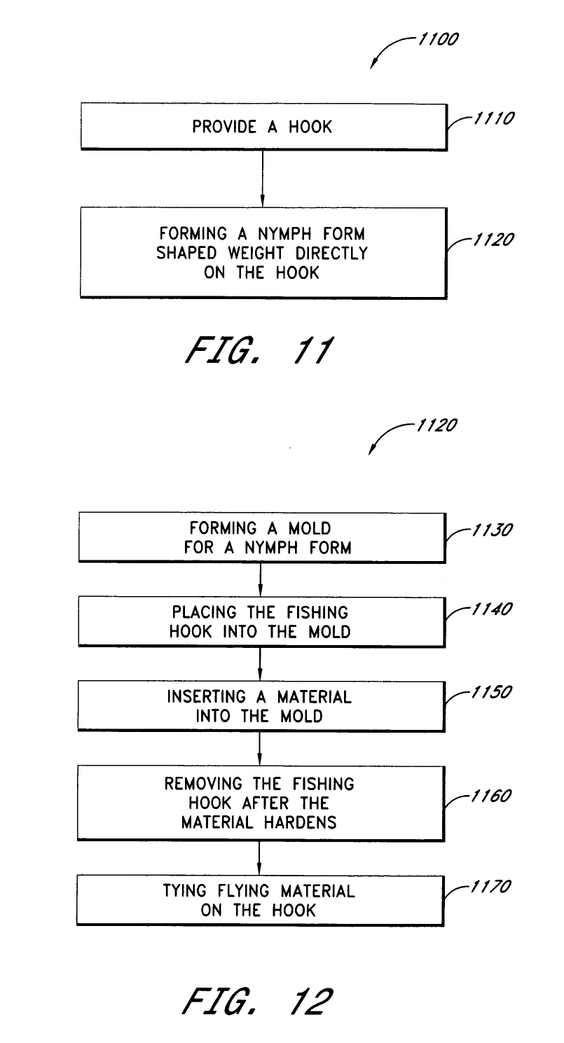

FIG. 12 illustrates a block diagram of further details of block 1120. In block 1130 a mold is first formed for a life form. In this embodiment, the mold has a first opening and a second opening. In this embodiment, the mold includes correct proportional spacing for grooves (such as groove 321 and 322) to ease fly tying and make the tying of a fly accurate. In block 1140, the fishing hook is placed into the mold. One end of the fishing hook extends through the first opening, and a second end of the fishing hook extends through the second opening.

In block 1150 a material is inserted or injected into the mold. In one embodiment the material is lead, tungsten, tin, bismuth, steel or a tungsten-nickel alloy, and the material inserted into the mold is in a molten state when inserted into the mold. In another embodiment the material is a ceramic material, rubber or plastic, and the material inserted into the mold is in a liquid state when inserted into the mold.

In block 1160 the fishing hook is removed after the material that was inserted or injected into the mold hardens. The removed fishing hook is integrated with the formed life form shaped weight. The formed life form shaped weight is accurately sized to an actual life form and proportioned to the size of the fishing hook that was provided.

In block 1170, the removed hook is then tied with fishing fly material (e.g., string, feathers, hackle, beads, yarn, wire, braid, dubbings, wax, hair, fur, cement, etc.) so that the molded nymph and hook can be used in fly fishing. In one embodiment, the fly material is tied manually by hand. In another embodiment the fly material is tied via a machine. In yet another embodiment, the fly material is tied by both machine and by hand.

In one embodiment the formed life form shaped weight has a head portion and a tail portion. When the fishing hook is removed from the mold the head portion is located in proximity to a through hole at one end of the fishing hook, and the tail portion is located in proximity to a barbed portion on the fishing hook.

It should be noted that while the embodiments discussed above include certain sizes for accurately shaped nymphs/insects, other sizes and shapes can also be made for additional nymph/insect shaped integrated weight and fishing hooks. Also, while certain dimensions are illustrated in FIGS. 3A through 10C, slight variations do not effect the scope of the embodiments. The dimensions illustrated were measured against actual nymph/insects. The above embodiments are ready for tying without a user having to figure out a size of a hook and a size of nymph to attach to a hook. The optional grooves facilitate tying fly material on the hook and prevent string from slipping off the nymph.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

1. A fly fishing apparatus comprising:
a hook; and
a life form shaped weight molded on the hook,
wherein the life form shaped weight is accurately sized and proportioned to a size of the hook for different types of nymphs, and the life form shaped weight is life sized, and the fly fishing apparatus is undecorated.

2. The fly fishing apparatus of claim 1, wherein the life form shaped weight includes at least one tying groove.

3. The fly fishing apparatus of claim 1, wherein the life form shaped weight is shaped as an insect, wherein the life form shaped weight is accurately sized and proportioned to a size of the hook for different types of insects.

4. The fly fishing apparatus of claim 1, wherein the life form shaped weight is made of one of lead, tungsten, tin, bismuth, steel and a tungsten-nickel alloy.

5. (canceled)

6. The fly fishing apparatus of claim 1, wherein a weight of the life form shaped weight is proportioned to the size of the hook.

7. The fly fishing apparatus of claim 1, the life form shaped weight has a head portion and a tail portion.

8. The fly fishing apparatus of claim 7, wherein the head portion is located in proximity to a through hole at one end of the hook, and the tail portion is located in proximity to a barbed portion on the hook.

9. The fly fishing apparatus of claim 1, wherein the life form shaped weight is made of one of a ceramic material, solid rubber, and plastic.

10. The fly fishing apparatus of claim 1, wherein the hook is centered within the life form shaped weight.

11. A fishing fly apparatus comprising:
an integrated hook and a life form shaped weight, the life form shaped weight being molded on the hook,
wherein a weight of the life form shaped weight is proportioned to a size of the hook for different sized nymphs, and the life form shaped weight is accurately sized and proportioned to a size of the hook for different types of nymphs, and the life form shaped weight is life sized, and the fly fishing apparatus is undecorated.

12. The fishing fly apparatus of claim 11, wherein the life form shaped weight includes at least one tying groove.

13. The fishing fly apparatus of claim 11, wherein the life form shaped weight is accurately sized to an insect, wherein the life form shaped weight is accurately sized and proportioned to a size of the hook for different types of insects.

14. The fishing fly apparatus of claim 11, wherein the nymph shaped weight is made of one of lead, tungsten, tin, bismuth, steel and a tungsten-nickel alloy.

15. The fishing fly apparatus of claim 11, wherein the life form shaped weight is made of one of a ceramic material, solid rubber, and plastic.

16. The fishing fly apparatus of claim 11, wherein the hook is centered within the life form shaped weight.

17. A method of forming an undecorated fly comprising:
selecting a predetermined life sized nymph form;
selecting a fishing hook based on a size of the selected nymph form; and
molding a life form shaped weight directly on the hook for the selected nymph form and fishing hook,
wherein the life form shaped weight is sized proportionally to a size of the hook for different types of nymphs.

18. The method of claim 17, further comprising:
forming a mold for a life form, the mold having a first opening and a second opening; and
placing the fishing hook into the mold,
wherein one end of the fishing hook extends through the first opening, and a second end of the fishing hook extends through the second opening.

19. The method of claim 18, wherein forming the life shaped weight further comprises:
inserting a material into the mold; and
removing the fishing hook after the material hardens,
wherein the removed fishing hook is integrated with the life form shaped weight.

20. The method of claim 19, wherein the material is one of lead, tungsten, tin, bismuth, steel and a tungsten-nickel alloy, and the material inserted into the mold is in a molten state when inserted into the mold.

21. The method of claim 19, wherein the material is one of a ceramic material, rubber, and plastic, and the material inserted into the mold is in a liquid state when inserted into the mold.

22. The method of claim 17, wherein the life form shaped weight is accurately sized to an actual insect, wherein the life form shaped weight is accurately sized and proportioned to a size of the hook for different types of insects.

23. The method of claim 18, the life form shaped weight having a head portion and a tail portion, wherein when the fishing hook is removed from the mold the head portion is located in proximity to a through hole at one end of the fishing hook, and the tail portion is located in proximity to a barbed portion on the fishing hook.

24. The method of claim 18, wherein the mold has a first portion for a first tying groove to be molded into the life form shaped weight.

25. The method of claim 24, wherein the mold has a second portion for a second tying groove to be molded into the life form shaped weight.

26. The method of claim 17, further comprising:
tying fly material onto the life form shaped weight and hook.
